(19) United States
(12) Patent Application Publication
(10) Pub. No.: US 2026/0019386 A1
(43) Pub. Date: Jan. 15, 2026

(54) BUFFER ALLOCATION FOR NETWORK DEVICES

(71) Applicant: MELLANOX TECHNOLOGIES, LTD., Yokneam (IL)

(72) Inventors: Chengchun Tu, Sammamish, WA (US); Parav Kanaiyalal Pandit, Bangalore (IN); Saeed Mahameed, San Jose, CA (US); Jiri Pirko, Chocen (CZ); Tariq Tokan, Haifa (IL); Yossi Kuperman, Haifa (IL)

(21) Appl. No.: 18/815,428

(22) Filed: Aug. 26, 2024

(30) Foreign Application Priority Data
Jul. 14, 2024 (IN) 202411053636

(51) Int. Cl. H04L 49/9005; H04L 47/30

(52) U.S. Cl. CPC H04L 49/9005; H04L 47/30

(57) ABSTRACT

Systems and methods herein for receive-buffer allocation in a network include at least one network interface controller (NIC) to handle receive requests for communication associated with a device. The at least one NIC can provide a fast path and a slow path for the communication. The slow path may be used for the communication based in part on a rule programmed in the at least one NIC, while one or more further rules in the at least one NIC can enable all of an available receive-buffer allocation for a buffer of the system based in part on burst or elephant flow in the communication, and can enable a threshold receive-buffer allocation that is less than the available receive-buffer allocation for the buffer based in part on at least one predetermined condition.

### CROSS-REFERENCE TO RELATED APPLICATIONS

This application is related to and claims the benefit of priority from Indian Patent Application No. 202411053636, filed on Jul. 14, 2024, the disclosure of which is incorporated by reference herein in its entirety for all intents and purposes.

### TECHNICAL FIELD

At least one embodiment pertains to network communications in a computing environment.

### BACKGROUND

Network communications may include a communication flow which may be associated with transmitting packets of a central processing unit (CPU) or associated CPU core that is executing an application. Further, such a CPU or CPU core, used interchangeably herein, may also be associated with incoming packets. The incoming packets belonging a communication flow may be handled by a receive side scaling (RSS) logic. The RSS logic uses receive queues to distribute incoming packets for different workloads. As a result, transmitting and receiving may progress with lower performance on different CPUs if there are bursts in the incoming packets as specific receive queues may be tied to specific CPUs. Further, a network device (NetDev) may be a data structure that is an abstraction layer and that may be used to communicate with other network devices using its own receive queue (RxQ) provided via one or more buffers. Further, each RxQ may be pre-allocated a certain size, such as 4 Mega Bytes (MB). The pre-allocation may be for a direct memory access (DMA) device associated between a NetDev, such as a network interface card (NIC), and the CPU. In one example, a 16-core system of a CPU may represent different devices and may be associated with different RxQs. There may be 16 RxQs for a CPU and for 1000 (or 1K) devices, there may be a total of 16 k RxQs, with total pre-allocated size of 64 Giga Bytes (GB). As such, there is possibility that some buffers of some RxQs are idle or unused even though allocated, when there is no traffic or no burst of traffic.

### BRIEF DESCRIPTION OF DRAWINGS

FIG. 1A is an illustration of a system for receive-buffer allocation in a network, in at least one embodiment;

FIG. 1B is an illustration of details in a slow path for receive-buffer allocation in a network, in at least one embodiment;

FIG. 2A is an illustration of further system details of a system for receive-buffer allocation in a network, in at least one embodiment;

FIG. 2B is an example approach associated with a packet processing function for receive-buffer allocation in a network, in at least one embodiment;

FIG. 3 is an illustration of further system details of a system associated with receive-buffer allocation in a network, in at least one embodiment;

FIG. 4 illustrates computer and processor aspects of a system for receive-buffer allocation in a network, in at least one embodiment;

FIG. 5 illustrates a process flow for a system for receive-buffer allocation in a network, in at least one embodiment;

FIG. 6 illustrates yet another process flow for a system for receive-buffer allocation in a network, in at least one embodiment;

FIG. 7 illustrates a further process flow for a system for receive-buffer allocation in a network, in at least one embodiment; and

FIG. 8 illustrates an exemplary data center and associated aspects to be used with a system for receive-buffer allocation in a network, in accordance with at least one embodiment.

### DETAILED DESCRIPTION

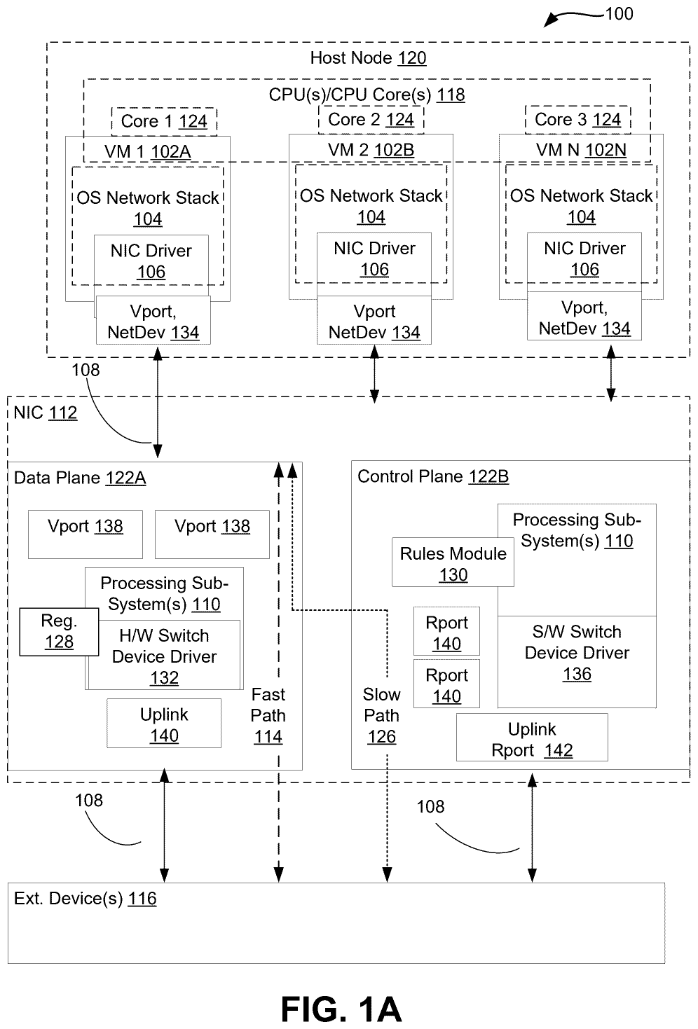

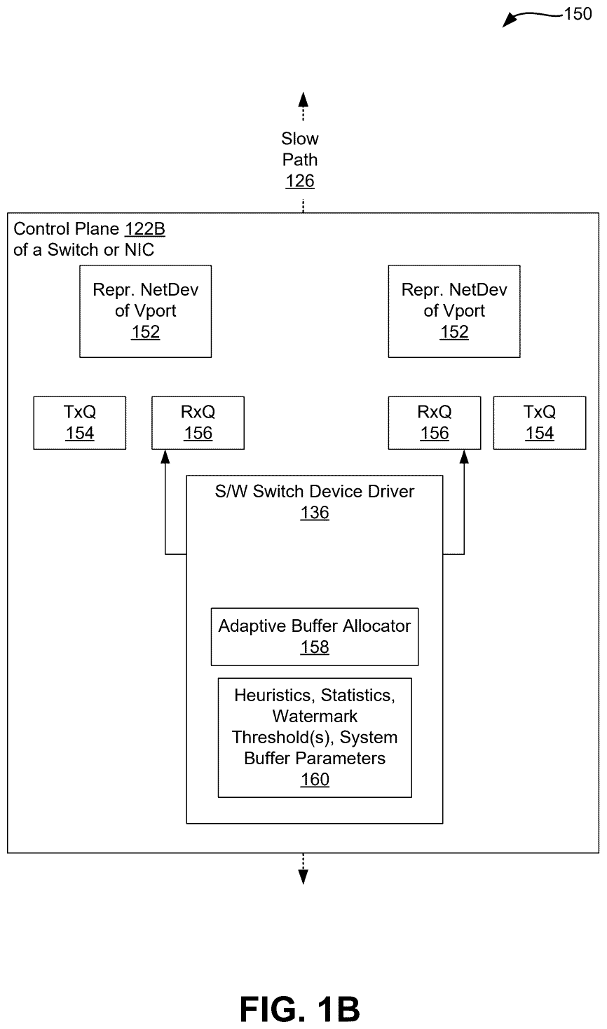

FIG. 1A is an illustration of a system 100 for receive-buffer allocation in a network, in at least one embodiment. The system is able to address the idle or unused even though allocated buffers based in part on traffic or communication that may burst of traffic. For instance, when a burst or elephant flow is detected in the traffic. For example, for non-burst or elephant flow in the traffic, a watermark threshold (also referred to generally as a threshold herein) may be introduced for each buffer that is under allocation. The threshold may be kept at a low watermark for non-burst or elephant flow in the traffic. The low watermark may be a minimum guarantee, in one example. Such a minimum guarantee may be to provide 128 buffers for a communication associated with a device and an external device. The device may be a virtual machine or container performed on a host node 120 and may be associated with one or more network devices (NetDevs) of one or more network interface cards (NICs).

The number of buffers may be dependent on the size of the buffers, but may be allocated according to a budget tied to an application programming interface (API). The API may be part of a device driver and its packet processing function. One or more API instances may be instantiated to perform at least aspects of the receive-buffer allocation. In one example, the API may be able to obtain a budget pertaining to packets in a workload. The minimum guarantee may be twice the budget in one example. However, for burst or elephant flow in the traffic, all of an available receive-buffer allocation may be provided for a device. Alternatively, a different threshold, such a high watermark threshold, different from a low watermark threshold for the non-burst or elephant flow in the traffic, may be used for the device.

Therefore, in one example, the system 100 may include processors that may be part of one or more processor sub-systems 110 of a network interface controller (NIC) 112. The NIC 122 may be a smartNIC and may include a data processing unit (DPU) as at least one of the one or more processor sub-systems 110. The system 100 may be for network communications to address burst communication or elephant flows in the network. The NIC 112 may be one of multiple NICs in the system 100. The NIC 112 may be associated with a fast path 114 and a slow path 126 to handle receive requests for communication 108 associated with a device, where the device may be represented by a CPU or a core 118. The NIC 112 may be able to provide a fast path 114 for the communication through a data plane 122A. The NIC 112 may be able to provide a slow path 126 for the communication through a control plane 122B. For example, based in part on a rule programmed in the NIC 112, the communication may be provided on the slow path 126 that is through the control plane 122B.

The fast path 114 is in reference to the communication being allowed therethrough using rules in a registry or table 128 and that can use a hardware (H/W) switch device driver 132 to connect to one or more external devices 116 that may be party in the communication from a host or host node 120. The slow path 126 is in reference to the communication being subject to a rule in the registry or table 128 and that can use a software (S/W) switch device driver 136 to connect to one or more external devices 116 that may be party in the communication from a host or host node 120. A control plane 122B may be able to enforce one or more rules from a rules module 130 to enforce receive-buffer allocation in the slow path 126 of a network. The one or more rules of the rules module 130 may be different from the rules programmed to a registry 128. For instance, the rules programmed to the registry 128 are essentially in hardware and allow for fast processing of the communication in the fast path 114, relative to the rules in the rules module 130 being applied via software in the slow path 126.

The one or more rules of the rules module 130 may be to enable all of an available receive-buffer allocation for a buffer in the slow path 126 of the system, as described further with respect to one or more of FIGS. 1B-8 herein. Further, while described in the singular, a buffer may be in reference to a collection of buffer memory that may in measured in Gigabytes or more of size. The enforcement of the one or more rules may be based in part on burst or elephant flow in the communication. The control plane 122B is also able to enforce one or more rules to enable a threshold receive-buffer allocation that is less than the available receive-buffer allocation for the buffer based in part on a non-burst or elephant flow in the communication, which is also described further with respect to one or more of FIGS. 1B-8 herein.

As such, the system 100 herein can be used with any standard input-output interfaces (IFs), including legacy IFs. As used herein, the communication may be in the form of packets and the receive request may be associated with buffer or receive queue size requests that may be based in part on the size of the communication. Further, the slow path 126 may be handled by the control plane 122B instead of a CPU(s) or CPU core(s) 118 of the system 100 or the data plane 122A of a NIC 112. The NIC 112 may be a smart Network Interface Controller (NIC) or may be associated with a smartNIC having the separate fast path and slow path features and forming a different system than a NIC, but capable of the same features described with a distinct data plane 122A and control plane 122B. The system 100 may include one or more circuits provided in the processors or processing units 110 and may include execution units as well. The processors may include one or more of a CPU, a graphics processing unit (GPU), or a DPU.

Further, the NIC 112 may be adapted for network communications 108 (also referred to herein as communications) that may represent or that may be the workload at issue. The NIC 112 may be adapted for network communications 108 with other external device(s) 116, in a slow path 126, using the S/W switch device driver 136. The S/W switch device driver 136 may be Open vSwitch® (OVS) bridge or a Linux® bridge. In one example, the NIC 112 may be supported by a NIC driver 106, which may be part of or may be in a location within a host node or machine 120 (such as, having an association with a CPU 118 of the host node 120. Further, an application may be in at least one of different virtual machines (VMs 1-N 102A-102N). However, it is also possible for the application to be one of different applications handled directly by an operating system (OS) network stack 104.

In at least one embodiment, an OS network stack 104 may include a collection of at least software to enable the various communication protocols that may be layered over each other. In one example, a communication protocol used with the system 100 herein may be a Transmission Control Protocol (TCP)-based connection. The OS network stack 104 herein can enable one or more applications, which may be each of the VMs 1-N 102A-102N or which may be independent applications, to communicate with physical network devices, such as a NIC 122 having a DPU. For example, the OS network stack 104 may invoke the NIC driver 106, which can communicate with the NIC 112 to transmit packets. The packets may be Ethernet packets, in one instance.

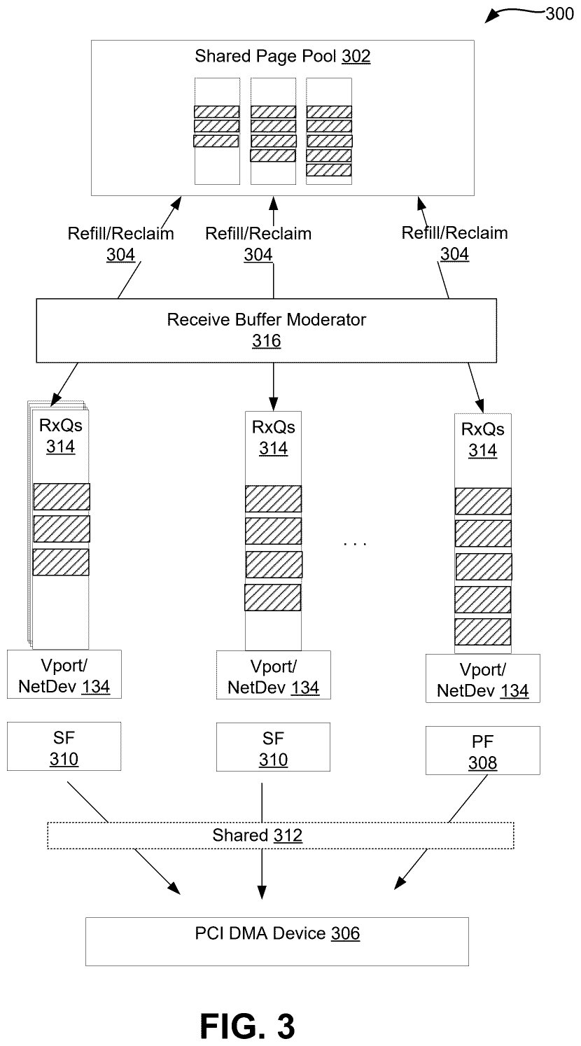

In one example, a NIC driver 106 may be loaded into a kernel of the host node 120 to perform aspects associated with a VM and/or a CPU core. The NIC driver 106 may create resources, including a virtual port (or Vport) 134, which may be provided as a virtual or software abstraction to represent a scalable function (SF) for the system 100. SFs 310, which are detailed further in FIG. 3, may be similar to virtual functions (VFs) and may be part of a Single Root I/O Virtualization (SR-IOV) of the peripheral component interconnect (PCI) Express (PCIe) standard. A PCIe device can present to a host node 120 as multiple distinct virtual devices. While the PCIe can include a physical function or PF 308 (also in FIG. 3) to provide control over creation and allocation of new VFs, the VFs may share a device's underlying hardware and PCIe for communication. The SR-IOV allows VFs to be lightweight to enable multiple VFs in a single device.

The SF implementation of a VF also allows support for a larger number of functions than VFs and enable multiple services to operate concurrently on the NIC 112. The SF 310 may have a parent PCIe function on which it is deployed and may, therefore, have access to capabilities and resources of its parent PCIe function, in addition to its own function capabilities and its own resources. The SF can have its own dedicated queues, as detailed further with respect to at least the RxQ 314 in FIG. 3. The SFs 310 may co-exist with PCIe VFs of a host node 120.

The NIC driver 106 may also create a network device (NetDev) that may be associated with the Vport (together or independently referenced using reference numeral 134) as the network device representative for a Vport 138 of a NIC 112, and with an interface for the OS network stack. The Vport, NetDev 134 combination referenced herein is with respect to functionality of the receive queues of the NIC 112 that may be associated to the Vport, NetDev 134 of the host node 120. Further, the NIC driver 106 may not interact with the Vports 134 and may use the SF instead. The host node's Vport/NetDev 134 may have a corresponding Vport 138 in the NIC 112. Separately, a Vport 138 of the NIC 112 can interact with hardware, such as the uplink 140 of the NIC 112 to further process packets of the communication for the external devices 116.

On the slow path 126 or control plane 122B side, if a communication encounters a miss with respect to the registry or table 128 by being a first communication from a device or subject to other rules from the registry 128, the communication may be provided to the slow path 126. The rules may be programmed to the registry 128 and may pertain to at least one predetermined condition. For example, the one predetermined condition may be one of: a non-burst or elephant flow in the communication 108, heuristics associated with a receive packet metadata indicative of a type of packet, a ratio of buffers of a receive queue to a total amount or number of buffers for all the receive queues of the at least one NIC 112, or statistics associated with packets per second (PPS) or bytes per second (BPS) for the receive queue of the buffer or associated with total values of the PPS and the BPS for the at least one NIC 112.

In the slow path 126 or the control plane 122B, representor ports (RPorts) 140 may be provided as a type of virtual port to map each host side physical function (PF) and scalable function (SF) to corresponding PF and SF of the NIC 112. Further, an Rports 140 can serve as a tunnel to pass traffic for bridge or switch 136 on behalf of an application of the CPU or CPU core 118. An Rport 140 may also serve as a channel to configure bridge or switch with one or more rules of the rules module 130. Further, in one example, the communication that is being offloaded to the NIC 112 may be provided through the uplink Rport 142.

A H/W switch device driver 132 of the NIC 112 can be associated with a registry 128 of rules for communications from one or more devices associated with the system 100. The registry 128 can be accessed by the H/W switch device driver 132 to enforce for requests pertaining to communications 108 from a host node 120. The registry 128 may be used to enforce a rule that a communication 108 coming through the NIC 112 is subject to a predetermined condition in at least the NIC 112 receiving the communication. On the other hand, a S/W switch device driver 136 of the NIC 112 may be used, instead, to process the communication in the slow path 126 using rules that are applied via software, from a rules module 130. The device used for the communication 108 in the system may be a virtual machine or container 102A-N which may be associated with a Vport 138 of a data plane 122A of the NIC 112, through at least one Vport and NetDev 134, and which may be associated with an Rport 142 of the control plane 122B of the NIC 112.

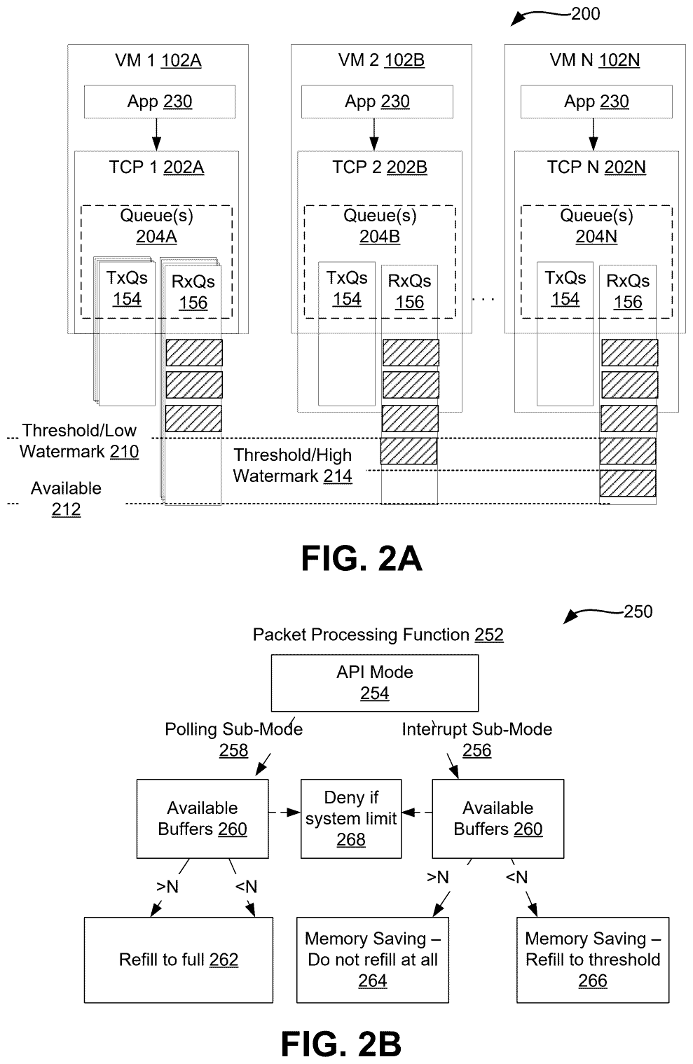

As illustrated, however, each of the applications (associated with each of the VMs 1-N 102A-102N, such as, in FIG. 2A) may be handled by a different CPU core 1-3 124 or different CPU(s) or CPU core(s) 118 of the host node 120. Therefore, although illustrated as a singular CPU, there may be different CPUs for different VMs. In at least one embodiment, packet offloading may ensure that incoming packets are handled by a receive side scaling (RSS) logic. In at least one embodiment, RSS logic, which is described further with respect to at least FIG. 1A may be a hardware logic (such as using a registry 128) of a NIC 112 to handle multiple hardware (H/W) receive queues (RxQ), also referred to herein as a receive queue 156 (also in FIG. 2A). These may be distinct from transmit queues (TxQ). In an example, a NIC driver 106 can communicate with a NIC 112 to support provision of the RxQs for each CPU or CPU core. There may be a predetermined number of such receive queues based in part on a capability of the NIC 112 and a capacity of the system 100. This may be also based, in part, on the processing sub-system 110. The NIC 122 can then distribute the received packets among queue(s) 156 of the communication protocols TCP 1-N 202A-202N using a respective hash generated from protocol headers associated with the received packets.

In an example, a hash allows the received packets to be maintained in a received order of a flow or stream. For example, the received order may be directed to a specific port so that intended packets are in the same receive queue among the maintained queue(s) of the OS network stack 104. In at least one embodiment, each of the OS network stack 104 maintains its own queue(s), as if it is an independent NIC, and which may include receive queues (RxQs) that are different from the receive queues of a NIC 112. Therefore, unless indicated otherwise, the reference to receive queues herein are to receive queues 156 of a NIC 112, and particularly, of receive queues of the control plane 122B.

Further, an RSS logic can enable load balancing in the packet processing aspects of network communications. Further, the Linux® kernel may support receive packet steering (RPS) as a software implementation of the RSS logic. RPS applies to a receive queue and enables packets to be provided in a per-CPU queue process. Further, RPS may provide filters for hash generation or uses hashes from a NIC. Still further, receive flow steering (RFS) is able to direct packet flows to a CPU or CPU core that performs a specific application. For example, RFS can be application-specific to prevent migration to another CPU or CPU core. RFS uses a flow table with a key generated from an RPS hash that is paired with a CPU to prevent migration of flows.

Each of the VMs 1-N 102A-102N may open a different TCP connection or different applications may be associated with different TCP connections. Such different TCP connections may be referred to herein as different communication protocols (such as, TCP 1-N 202A-202N in FIG. 2A). The device driver 132 may be able to determine a burst in a flow in the communications 108 based in part on a size indication associated with the communications or based on monitoring of the communication being tied to a single TCP connection, for instance. In one example, as used herein, a burst or an elephant flow may be in reference to a large continuous flows associated with a single application, such as, a single VM. In one example, a burst or an elephant flow in a network link supporting a communication 108 may be larger than 1 GB/10 seconds. In one example, an elephant flow can consume a substantial portion of a network's bandwidth within a predefined period.

The size indication may be based in part on one or more of bytes per second of one flow associated with one of the different communication protocols, relative to other flows in the communications; a packet count relative to other flows in the communications; or a large send offload. For example, the size indication may be a predetermined bytes per second of one flow associated with one of the communication protocols, relative to other flows in the communications 108. Alternatively, a size indication may be a packet count relative to other flows in the communications 108. In yet another example, a size indication may be a large send offload indicated initially with one of the communications 108.

The rules module 130 may provide the one or more rules for enforcing in the slow path 122B of the NIC 112. The rules may include a fairness rule which may be provided to enable different devices in the system 100 to receive respective available receive-buffer allocations for their respective buffers RxQs. This approach can prevent a single one of the different devices from receiving the available receive-buffer allocation at least once during the burst or elephant flow in the communication or in a subsequent communication. Therefore, other devices may benefit from available receive-buffer allocation during burst or elephant flows and at least one device that may have had a prior available receive-buffer allocation may remain deficient. The fairness rule may be based in part on a count associated with a number of the available receive-buffer allocation made to the device over a period of time or a number of communications for the device.

FIG. 1B is an illustration of details 150 in a slow path for receive-buffer allocation in a network, in at least one embodiment. While the control plane 122B in FIG. 1A is described with reference to a NIC, FIG. 1B illustrates that the control plane 122B may be also used for a physical switch with multiple ports therein. In one example, in addition to the description of the control plane 122B with respect to a NIC 112 in FIG. 1A, the control plane 122B may include representative NetDevs 152 of respective Vports of a NIC in the use case of a switch. The representative NetDevs 152 may be associated with respective TxQs 154 and RxQs 156.

Further, FIG. 1B also illustrates that the S/W switch device driver 136 of the control plane 122B may include an adaptive buffer allocator 158 that may be part of or independent of the rules module 130. For example, the rules module 130 may maintain the rules to be enforced by the adaptive buffer allocator 158 that can cause dynamic receive-buffer allocation for the receive queues 156 of the respective representative NetDevs 152. Further, the S/W switch device driver 136 may include a module for heuristics, statistics, watermark threshold(s), and system buffer parameters 160, which may provide or enable predetermined conditions for the rules to be applied by the adaptive buffer allocator 158 towards causing the dynamic receive-buffer allocation for the receive queues 156.

For instance, the slow path 126 may be used based in part on a rule programmed in the at least one NIC, and being the fast path 114, that may transfer the communication or cause the communication to pass from the fast path 114 to the slow path 126. There may be one or more further rules in the NIC, such as in the slow path 126, that can enable all of an available receive-buffer allocation for a buffer of the system 100 based in part on burst or elephant flow in the communication. Additionally, the one or more further rules in the NIC can also enable a threshold receive-buffer allocation that is less than the available receive-buffer allocation for the buffer, based in part on at least one predetermined condition. Therefore, there may be more than non-burst or elephant flow in the communication that may be a basis for providing the threshold receive-buffer allocation that is less than the available receive-buffer allocation for the buffer that causes the dynamic receive-buffer allocation for the receive queues 156.

The at least one predetermined condition may be one of a non-burst or elephant flow in the communication, heuristics associated with a receive packet metadata indicative of a type of packet, a ratio of buffers of a receive queue to a total amount or number of buffers for all the receive queues of the at least one NIC, or statistics associated with packets per second (PPS) or bytes per second (BPS) for the receive queue of the buffer or associated with total values of the PPS and the BPS for the at least one NIC. The buffer parameters 160 may be in reference to maximum limits (such as, sizes) of the total available buffers of the system 100. Otherwise, the system 100 may be at limit without an ability to perform any further dynamic receive-buffer allocation.

FIG. 2A is an illustration of further system details of a system 200 for receive-buffer allocation in a network, in at least one embodiment. The system 200 of FIG. 2A may be within the system 100 already described with respect to FIGS. 1A and 1B. However, the system 200 in FIG. 2A may be separate or in addition to aspects in the system 100 already described with respect to FIGS. 1A and 1B. In one example, the system 200 in FIG. 2A may include at least one processor, such as in a NIC 112 that may include a DPU and that may be provided for communications 108 to one or more external device(s) 116. The NIC 112 may form part of a system that can be associated with different communication protocols TCP 1-N 202A-202N. The different communication protocols may represent different open connections operating concurrently for different applications 230 that can invoke a respect one of the different communication protocols TCP 1-N 202A-202N. For example, different VMs 1-N 102A-102N may be associated with different open connections or the different communication protocols TCP 1-N 202A-202N.

Further, each of the different communication protocols TCP 1-N 202A-202N may be associated with a different queue(s) as described and illustrated with respect to one or more of FIGS. 1B, 2A, and 3 herein. Each of such different queue(s) may be associated with a respective one or more transmit queues (TxQs) 154 and one or more receive queues (RxQs) 156 on the NIC 112. FIG. 2A illustrates that, for non-burst or elephant flow in the traffic, a low watermark threshold watermark 210 may be introduced for each buffer having a RxQ 156 that is under allocation. The low watermark threshold 210 may be kept at the low watermark for non-burst or elephant flow in the traffic. The low watermark threshold may be a minimum guarantee, in one example. Such a minimum guarantee may be to provide a guaranteed number of buffers (such as, 128 buffers) for a communication 108 associated with a device and an external device 116. The number of buffers may be dependent on the size of the buffers, but may be allocated according to a budget tied to an API. The API may be part of a device driver and its packet processing function and may be able to obtain a budget pertaining to packets in a workload. The minimum guarantee may be twice the budget in one example.

However, for non-burst or elephant flow in the traffic or for any predetermined conditions as discussed with at least FIG. 1B, all of an available receive-buffer allocation may be provided for a device. Alternatively, a different threshold 212, such a high watermark threshold, different from a low watermark threshold may be used for the device, for the non-burst or elephant flow or the predetermined conditions being satisfied in the traffic. In either case, a low or high watermark threshold may be different thresholds than providing all of an available 212 available receive-buffer allocation.

FIG. 2B is an example approach 250 associated with a packet processing function for receive-buffer allocation in a network, in at least one embodiment. The approach 250 reflects, in one example, a process for determination of the threshold or removal thereof with respect to the receive-buffer allocation herein. To determine a receive-buffer allocation for a threshold, such as for 64*2 buffers (or 128 buffers), an API_POLL_WEIGHT parameter may be established. While all available receive-buffer allocation may be 1024 buffers (or queue depth) by default, it is possible to use a factor of the API_POLL_WEIGHT parameter to establish the threshold. For instance, the system 100, 200 may be subject to an API that can function with interrupt-driven networking, as well as polling-driven networking to handle network traffic. The packet processing function 252 may be part of a hardware switch device driver of the NIC or may be associated with the control plane of the NIC to determine a receive-buffer allocation.

Interrupt-driven networking may use device drivers in the NIC, for instance, that rely on interrupts from the NIC seeking to provide received communications to appropriate devices. Therefore, the NIC may receive a new packet and may trigger an interrupt to notify a device, such as a CPU or a CPU core. The CPU or CPU core stops its current task to handle the interrupt by processing the packet, in one instance. Further, polling-driven networking allows a CPU or a CPU core to periodically check for new packets. The API mode 254, however, combines such different driven networking to allow for interrupt sub-mode 256 to occur for notification, where NetDevs can generate interrupts when new packets arrive, but the interrupts may not trigger packet processing. Instead, an interrupt handler may be part of the packet processing function 252 to schedule an API instance to be performed at a later time. Further, the later time may be based in part on scheduling using a clock input or reference in the packet processing function 252. Still further, the packet processing function 252 may use a threshold (“N”) based on the API_POLL_WEIGHT parameter to cause the API instance to be performed.

Separately, in the polling sub-mode 258, it is possible to support polling of scheduled API instances at any time. The polling may retrieves waiting packets from a device and may perform batch processing to adjust context switching and related overheads. In this sub-mode as well, the packet processing function 252 may use a threshold (“N”) based on the API_POLL_WEIGHT parameter to cause the API instance to be performed. However, in the polling sub-mode 258, receive-buffer allocation may occur for all the available buffers 260 no matter the threshold. That is, the receive-buffer allocation may refill to full the buffers associated with ongoing processing for one or more NetDevs. Differently, in the interrupt sub-mode 256, receive-buffer allocation may occur for all the available buffers 260 in a manner where refill 266 to a threshold N occurs when a current receive-buffer allocation is lesser than the threshold N, but no refill 264 of the buffers may be performed a current receive-buffer allocation is greater than the threshold N. Separately, however, if the system buffer parameters 160 are indicative of a limit reached, the packet processing function 252 may return a denial 268 for any receive-buffer allocation request.

Therefore, the receive-buffer allocation herein benefits from the refill process described in the approach of FIG. 2B by allowing requests for memory from system 100. When the API of the API mode 254 is busy, then refill 262, 266 may be performed to the available receive-buffer allocation, which may be the full queue depth or 1024 entries (also representing a maximum transmit unit (MTU) size). However, when the API is in the interrupt sub-mode 256, implying that it is not busy, the refill 262, 266 may be performed to a low watermark threshold 210, if the current receive-buffer allocation is less that then the low watermark threshold 210. Then, it is possible for the system 100 to support reclaim or returning of receive-buffer allocation to system 100. For example, when the API is busy, the reclaiming may not be performed and when the API is not busy or available in the interrupt sub-mode 256, then refill may not be performed if a current receive-buffer allocation is greater than the low watermark threshold 210, representing memory saving ongoing. However, when APIs of every device is busy, then it may be the case that the devices are allocated the full available receive-buffer allocation. In one example, this may be performed to prevent a system out-of-memory occurrence when scaling to 1K or 2K devices in the system 100.

FIG. 3 is an illustration of further system details of a system 300 associated with receive-buffer allocation in a network, in at least one embodiment. The system 300 of FIG. 3 may be within the system 100 already described with respect to FIG. 1. However, the system 300 in FIG. 3 may be separate or in addition to aspects in the system 100 already described with respect to FIG. 1. The system 100 may benefit from a shared page pool 302 which may include a large distribution of buffers. Therefore, the RxQs herein may share the shared page pool 302 for all the devices in the system 100.

Further, a shared page pool 302 may be used to support the fairness rule of the rule module 130. As a result, it is possible for each device or NetDev to not always include a full available receive-buffer allocation. Instead, taking a current available memory into consideration, it is possible to dynamically adjust the receive-buffer allocation. In one example, in the API busy mode, a max_usage parameter may be applied for a device. The max_usage parameter may be derived from an equation of alpha/(1+alpha)*Free_Buffer. The Free_Buffer may be available buffer of the shared page pool 302 that has not been subject to receive-buffer allocation, and Alpha may be a variable that may be suited to the system 100 and may be based in part on the system buffer parameters established for the system 100. When alpha is designated a value of 1, max_usage may be ½*Free_buffer. For instance, when the Free_buffer is 10 GB, the buffer designation for multiple devices, with the API is a busy mode, may be 0.5*10 GB=5 GB.

In an example where a total memory of 20 MB may be a system buffer parameter that is established for the system 100 and that may be available to be shared with ten (10) NetDevs, the system 100 herein may initiate a 1 to 10 sequence of receive-buffer allocation with only low-watermark threshold for each. For instance, Netdev 1 of the 10 NetDevs may have a receive-buffer allocation of 256 buffers, which assumes a 4K page and a total of 1 MB. Then, the total of NetDevs 1 to 10 may have receive-buffer allocation of 256*10*4K page for a total 10 MB. Therefore, there may be a currently Free_Buffer in a shared page pool 302 of 20 MB−10 MB=10 MB. When a burst of traffic arrives to NetDev 1 and 2 of the 10 NetDevs and when alpha has a value of 1, a max_usage may be determined as is ½*Free_buffer such that at Time 0, the Free_buffer has 10 MB with NetDev 1 entering into a default receive-buffer allocation state of 1024 entries. There may be a request for 4 MB which is less than the max_usage (i.e., less than 10 MB/2=5 MB). As such, a pass may be initiated towards any receive-buffer allocation for NetDev 1. Also, just after Time 1, the Free_buffer may be at 7 MB (provided by 20 MB−1*4 MB−9*1 MB).

At Time 2, NetDev 2 of the 10 NetDevs may enter a default allocation of 1024 entries and may request 4 MB which is greater than the current max_usage of 7 MB/2 or 3.5 MB. Therefore, a fail or denial may be initiated towards any receive-buffer allocation for NetDev 2. However, a partial receive-buffer allocation may occur with 3.5 MB for NetDev 2. Then, just after Time 2, the Free_buffer may be at 3.5 MB. At Time 3, when NetDev 1 of the 10 NetDevs finishes performing its burst or elephant flows, there may be a reclaim or return of 3 MB back to shared page pool 302. Further, just after Time 3, the Free_buffer may be at 3 MB+3.5 MB=6.5 MB.

In at least one embodiment, there may be multiple NetDevs 134 supported in the system 100, as illustrated in FIG. 1 and by the multiple NetDevs in FIG. 3. The available receive-buffer allocation may be from the shared page pool 302 of the system 100. The multiple NetDevs 134 may also share 312 a direct memory access (DMA) device 306, which utilizes the available receive-buffer allocation for the buffer. For instance, when a NIC 112 receives packets as part of a communication, the NIC 112 may store such packets to a memory. A NetDev and the device driver 132 may manage the packet using information, such as a packet size. The DMA device 306 may be peripheral component interconnect (PCI) DMA device of the NIC 112 and may be initiated by the device driver 132 to perform a DMA transfer for the packets. The PCI DMA device 306 can control and perform the transfer of packets directly from memory of the NIC 112 to a system memory of the host node 120 without CPU intervention. However, the CPU or a CPU core may be interrupts by the PCI DMA device 306 to provide notifications of the transfer for the CPU or CPU core to access and process the packets.

In FIG. 3, the PF refers to a primary function of a NIC 112 and represents a mode of operation for the NIC. A NetDev 134 can represent the PF of the NIC 112 in certain instances. A device driver 132 may be associated with a NetDev of a host node 120 to support interaction between the NIC 112 and the host node 120. Such interaction may include sending and receiving packets and managing settings therein. In one example, however, the NIC 112 may be partitioned into virtual functions (VFs) or SFs 310, where the SFs 310 may also be represented by separate NetDevs 134 and may be able to benefit from the receive-buffer allocation in a network described herein.

The system 100 herein may be such that available receive-buffer allocation is based in part on a state of an API of the device. For instance, as described with respect to at least FIG. 2B, when the API is in a busy state, the buffer is to comprise all the available receive-buffer allocation as part of the refill or reclaim 304 process with respect to the shared page pool 302. However, when the API is not in the busy state, the buffer is to receive the threshold receive-buffer allocation. Further, when the API is not in a busy state, the NIC 112 can support reclaiming 304 of part of the available receive-buffer allocation buffer from the buffer to a shared page pool 302 to provide the threshold receive-buffer allocation for the buffer.

Further, in FIG. 3, before an RxQ 314 can access a shared page pool 302, there may be several checks to completed in a dedicated software module in the system 300. The checks may be completed in a receive buffer moderator 316, where one or more of the checks may pertain to fairness and may be enforced with support from the rules module 130 in FIG. 1A, as well as the adaptive buffer allocator 158 and the Heuristics, Statistics, Watermark Threshold(s), System Buffer Parameters module 160 in FIG. 1B. One of the checks may include a check to verify or determine that a buffer allowance exists based in part on the heuristics, statistics, system buffer parameters (or global limits), and proportion of a buffer per RxQ 314, with respect to global limits. Some or all such information may be provided from the Heuristics, Statistics, Watermark Threshold(s), System Buffer Parameters module 160 in FIG. 1B. When the module 160 grants or indicates a grant a page or buffer allocation for an RxQ 314, a request may be then made to the shared page pool 304. However, if the module 160 denies or indicates a denial, the buffer may not be posted to the RxQ 314 from the shared page pool 302.

Therefore, the fairness rule is of a rules module 130 may be enforced in part using a buffer moderator module 316 to perform one or more checks prior to granting access for one or more of the threshold receive-buffer allocation or the available receive-buffer allocation, from a shared page pool, for at least one of the receive requests. Further, one or more SFs 310 maybe associated with a PF 308 within the same system 300 can share and use the buffer moderator module 316, as illustrated. Broadly, however, a SR-IOV-enabled device, such as the SF 310, associated with a PF 308, can share and use the buffer moderator module 316, can share and use the buffer moderator module 316.

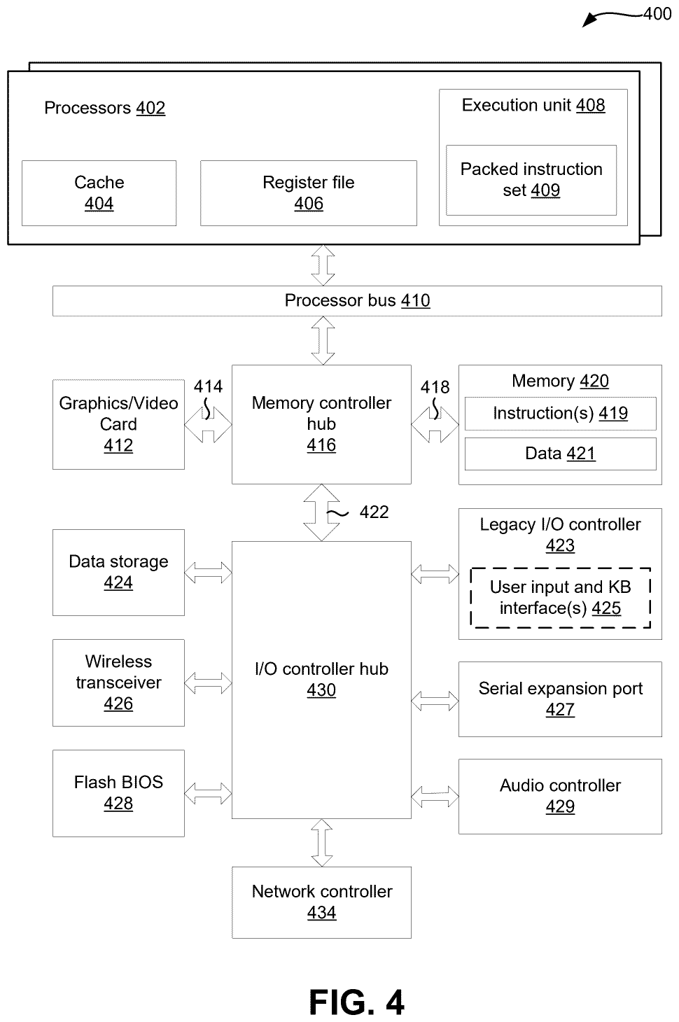

FIG. 4 illustrates computer and processor aspects 400 of a system for receive-buffer allocation in a network, in at least one embodiment. For example, each of the illustrated processors 402 may include one or more processing or execution units 408 that can perform any or all of the aspects of the system 100 for receive-buffer allocation in association with one circuit or more circuits being part of a system 100 in a computing environment. The system 100 may include the one or more processing or execution units 408 in one or more host machines in a computing environment.

The processing or execution units 408 may include multiple circuits to support the aspects described herein for one or more of the system 100-300 for receive-buffer allocation. In at least one embodiment, the processors herein may include CPUs or DPUs that may be associated with a multi-tenant environment to perform or be associated with the system 100 for receive-buffer allocation, described herein. Further, a NIC of the system 100 may be represented by a network controller 434 and a CPU may be represented by the processors 402, as illustrated in FIG. 4. Therefore, even though described in the singular, the network controller 434 may include multiple cards and may include multiple DPUs on each card.

The computer and processor aspects 400 may be performed by one or more processors 402 that include a system-on-a-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1A-3 and 5-8 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processors 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating-point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processors 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414. In at least one embodiment, the graphics/video card 412 may be coupled to one or more of the processors 402 via a PCIe interconnect standard. Similarly, a network controller 424 may also be coupled to one or more of the processors 402 via a PCIe interconnect standard.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processors 402. Examples may include, without limitation, an audio controller 429, a firmware hub (“flash BIOS”) 428, a wireless transceiver 426, a data storage 424, a legacy I/O controller 423 containing user input and keyboard interface(s) 425, a serial expansion port 427, such as a Universal Serial Bus (“USB”) port, and a network controller 434. In at least one embodiment, data storage 424 may comprise a hard disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

Therefore, the at least one execution unit 408 may be one or more circuits of the illustrated processors 402 and can include or be associated with a system 100 for receive-buffer allocation. The one or more circuits can provide at least one NIC having a DPU as part of the system 100 that can handle receive requests associated with communication for a device. The device may be a NetDev represented in at least one NIC. The system may include a fast path and a slow path for the communication provided by the NIC. The slow path may be used based in part on a rule programmed in the at least one NIC. In addition, a first one of further rules in the at least one NIC can enable all of an available receive-buffer allocation for a buffer of the system based in part on burst or elephant flow in the communication. The first one or a second one of the further rules may also enable a threshold receive-buffer allocation that is less than the available receive-buffer allocation for the buffer based in part on at least one predetermined condition.

The at least one predetermined condition can be one of a non-burst or elephant flow in the communication, heuristics associated with a receive packet metadata indicative of a type of packet, a ratio of buffers of a receive queue to a total amount or number of buffers for all the receive queues of the at least one NIC, or statistics associated with packets per second (PPS) or bytes per second (BPS) for the receive queue of the buffer or associated with total values of the PPS and the BPS for the at least one NIC. The receive packet metadata may include size, source, destination, and other information pertaining to an overlying communication.

The one or more circuits may be such that a rules module can be provided in the NIC to provide the one or more rules. The one or more rules may include a fairness rule which is to enable different devices in the system 100 to receive respective available receive-buffer allocations for their respective buffers. The one or more rules is also to prevent the device from receiving the available receive-buffer allocation at least once during the burst or elephant flow in the communication or in a subsequent communication.

The one or more circuits may also be so that the fairness rule is based in part on a count associated with a number of the available receive-buffer allocation made to the device over a period of time or a number of communications for the device. The one or more circuits may also include or support multiple NetDevs. Then, the available receive-buffer allocation may be from a shared page pool of the system 100. The multiple NetDevs can share a DMA device which utilizes the available receive-buffer allocation for the buffer. Further, the one or more circuits may be such that the available receive-buffer allocation is based in part on a state of an API of the device, which is detailed with respect to at least FIG. 2B herein.

The one or more circuits may also include a hardware switch device driver and a software switch device driver. The hardware switch device driver may support programmed rules of the NIC, whereas the software switch device driver may support rules applied via software of the NIC. The hardware switch device driver can maintain programmed rules associated with communications from one or more devices of the system to support the fast path. However, the hardware switch device driver can also cause the communication to be provided for the slow path based on at least one predetermined condition, as detailed with respect to at least FIG. 1B. The software switch driver can process the communication in the slow path. The device and the one or more devices subject to such fast path and slow path communications may be virtual machines or containers which are associated with a virtual port and with a representor port of the NIC.

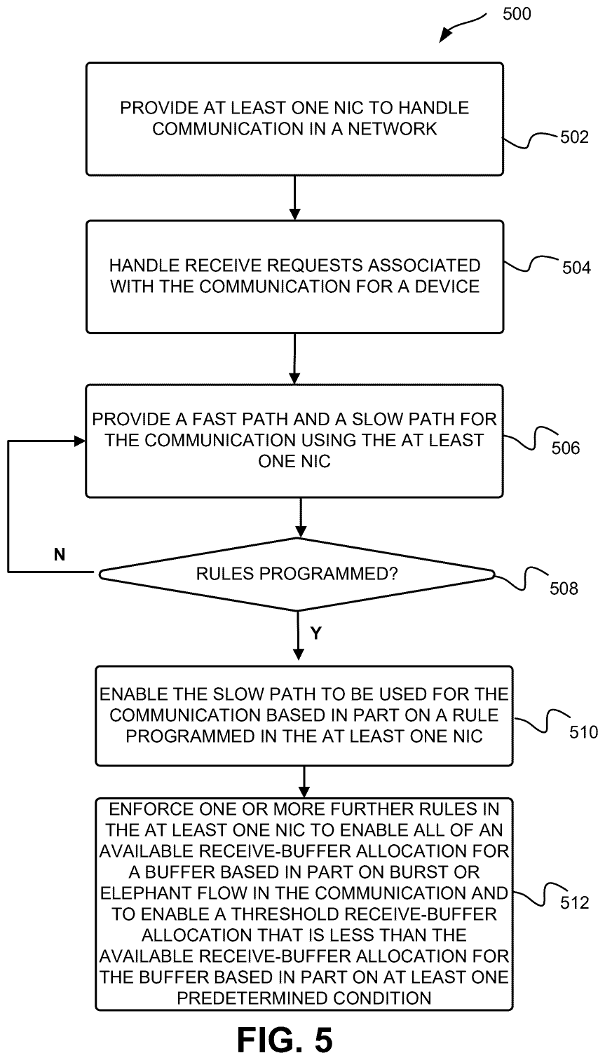

FIG. 5 illustrates a process flow or method 500 for a system for receive-buffer allocation in a network, in at least one embodiment. The method 500 may include providing 502 at least one NIC to handle communication in a network. The method 500 may include handling 504 receive requests associated with the communication for a device. The method 500 may include providing 506 a fast path and a slow path for the communication using the at least one NIC. The method 500 may also include a verification or determination 508 performed for the NIC include programmed rules. For example, a registry of the NIC may include programmed rules to be applied to transfer or enable communication to be performed in the slow path instead of the fast path. The method 500 may include enabling 510 the slow path to be used for the communication based in part on a rule programmed in the at least one NIC. The method 500 may include enforcing 512 one or more further rules in the at least one NIC to enable all of an available receive-buffer allocation for a buffer based in part on burst or elephant flow in the communication. However, the enforcing 512 may be also to enable a threshold receive-buffer allocation that is less than the available receive-buffer allocation for the buffer based in part on at least one predetermined condition.

The at least one predetermined condition may be one of: a non-burst or elephant flow in the communication, heuristics associated with a receive packet metadata indicative of a type of packet, a ratio of buffers of a receive queue to a total amount or number of buffers for all the receive queues of the at least one NIC, or statistics associated with packets per second (PPS) or bytes per second (BPS) for the receive queue of the buffer or associated with total values of the PPS and the BPS for the at least one NIC.

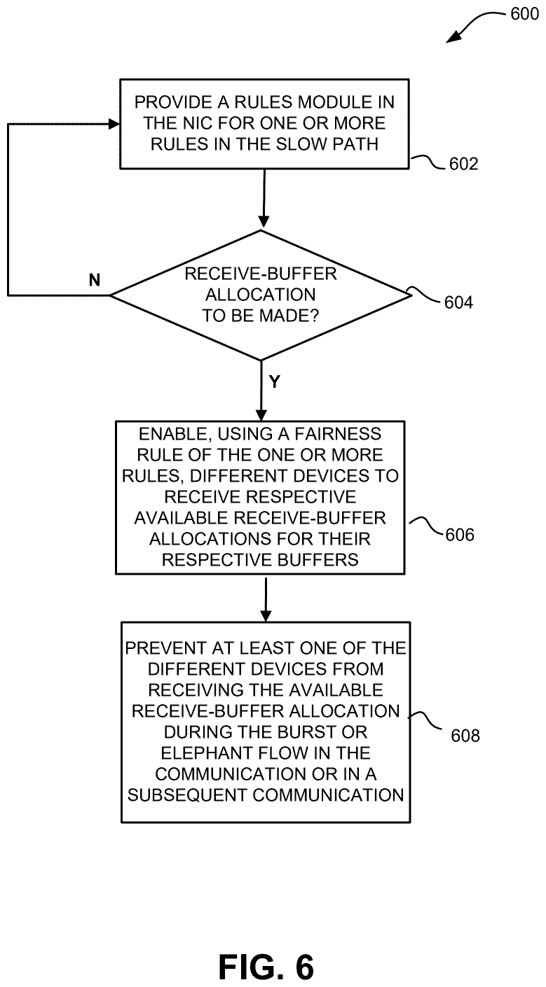

FIG. 6 illustrates yet another process flow or method 600 for a system for receive-buffer allocation in a network, in at least one embodiment. The method 600 may be used in conjunction with the method 500 of FIG. 5, in at least one embodiment. The method 600 in FIG. 6 may include providing 602 a rules module in the NIC for the one or more rules in the slow path. The method may include verification or determining 604 that a receive-buffer allocation is to be made. This may be the case based in part on the programmed rules in the NIC, in support of steps 508, 510 in FIG. 5. For instance, if the programmed rules indicate that the communication source, target, size, or type satisfies a threshold or criteria, the communication may be moved to the slow path. The method 600 may include enabling 606, using a fairness rule of the one or more rules, different devices to receive respective available receive-buffer allocations for their respective buffers. The method 600 may also include preventing 608 at least one of the different devices from receiving the available receive-buffer allocation during the burst or elephant flow in the communication or in a subsequent communication.

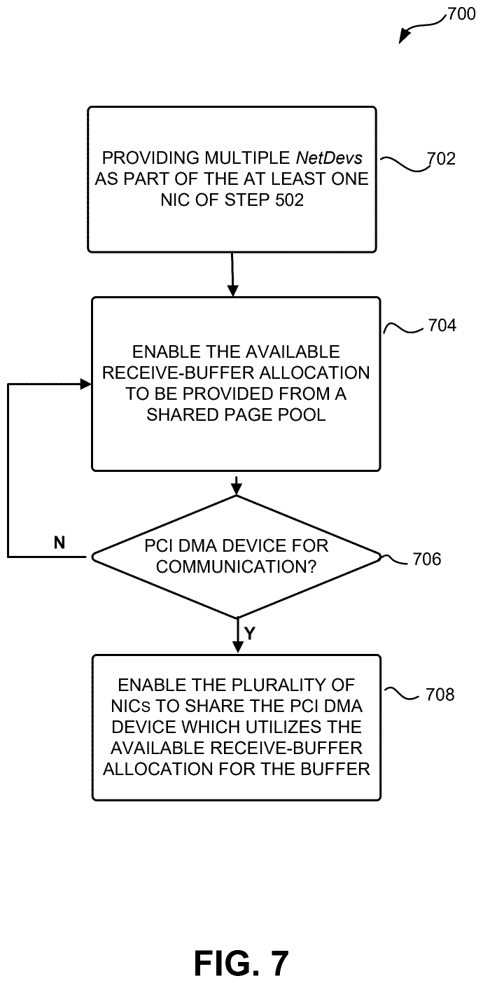

FIG. 7 illustrates a further process flow or method 700 for a system for receive-buffer allocation in a network, in at least one embodiment. The method 700 may be used in conjunction with one or more of the methods 500, 600 of FIGS. 5 and 6, in at least one embodiment. The method 700 in FIG. 7 may include providing 702 multiple NetDevs as part of the at least one NIC of step 502 in FIG. 5. The method 700 may include enabling 704 the available receive-buffer allocation to be provided from a shared page pool. The method 700 may include verifying or determining 706 that a PCI DMA device is ready for communication. For example, once the received packets are ready, the PCI DMA device may be ready to perform transfer of the packets. The method 700 may include enabling 708 the multiple NetDevs to share the PCI DMA device which utilizes the available receive-buffer allocation for the buffer.

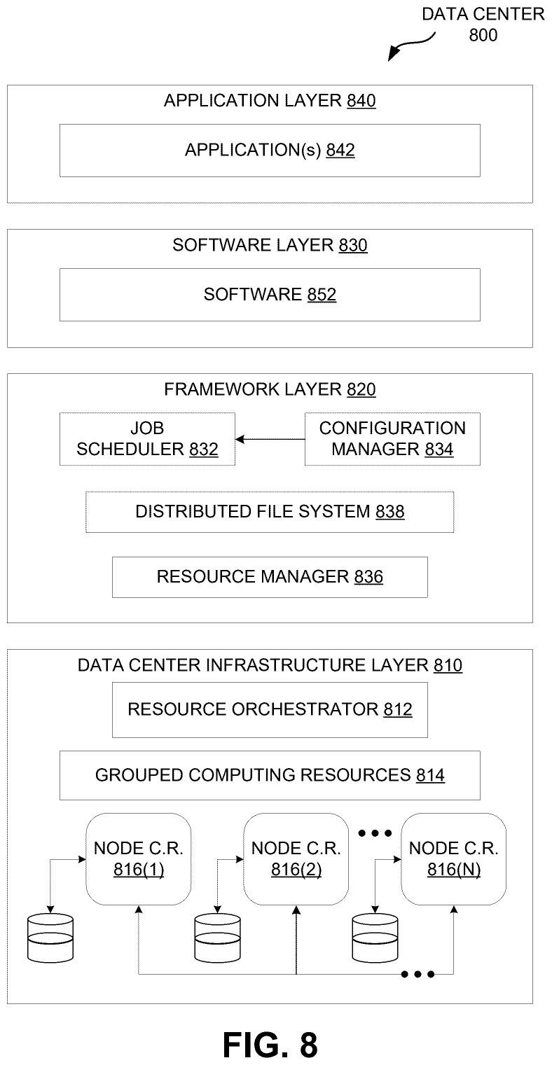

FIG. 8 illustrates an exemplary data center 800 and associated aspects to be used with a system for receive-buffer allocation in a network, in accordance with at least one embodiment. In at least one embodiment, the data center 800 includes, without limitation, a data center infrastructure layer 810, a framework layer 820, a software layer 830 and an application layer 840, to perform aspects according to techniques described with respect to at least one or more of FIGS. 1A-7 herein. For example, the exemplary data center 800 is able to handle burst or elephant flows by at least processors of a system 100-300 that may be a computing resource 816(1)-816(N) for handling network communications. Such a computing resource 816(1)-816(N) may be associated with aspects for receive-buffer allocation in a network.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of DPUs, central processing units (“CPUs”) or other processors (including accelerators, field programmable gate arrays (“FPGAs”), graphics processors, etc.), memory devices (e.g., dynamic read-only memory), storage devices (e.g., solid state or disk drives), network input/output (“NW I/O”) devices, network switches, VMs, power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes, without limitation, a job scheduler 832, a configuration manager 834, a resource manager 836 and a distributed file system 838. In at least one embodiment, framework layer 820 may include a framework to support software 852 of software layer 830 and/or one or more application(s) 842 of application layer 840. In at least one embodiment, software 852 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820, including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resources 814 at data center infrastructure layer 810. In at least one embodiment, resource manager 836 may coordinate with resource orchestrator 812 to manage these mapped or allocated computing resources.

In at least one embodiment, software 852 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. In at least one or more types of applications may include, without limitation, CUDA applications.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, associated aspects of the data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, DPUs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

FIG. 8 also sets forth, without limitation, exemplary computer-based systems that form associated aspects that can be used with the data center 800 to implement at least one embodiment. For example, the data center 800 includes a processing system, in accordance with at least one embodiment. In at least one embodiment, the processing system may include one or more processor(s) and one or more graphics processor(s), and may be a single processor desktop system, a multiprocessor workstation system, or a server system having a large number of processor(s) or processor core(s). In at least one embodiment, the processing system is a processing platform incorporated within a system-on-a-chip (“SoC”) integrated circuit for use in mobile, handheld, or embedded devices.

In at least one embodiment, the processing system can include, or be incorporated within a server-based gaming platform, a game console, a media console, a mobile gaming console, a handheld game console, or an online game console. In at least one embodiment, the processing system is a mobile phone, smart phone, tablet computing device or mobile Internet device. In at least one embodiment, the processing system can also include, coupled with, or be integrated within a wearable device, such as a smart watch wearable device, smart eyewear device, augmented reality device, or virtual reality device. In at least one embodiment, the processing system is a television or set top box device having one or more processor(s) and a graphical interface generated by one or more graphics processor(s).

In at least one embodiment, the one or more processor(s) each include one or more processor core(s) to process instructions which, when executed, perform operations for system and user software. In at least one embodiment, each of one or more processor core(s) is configured to process a specific instruction set. In at least one embodiment, an instruction set may facilitate Complex Instruction Set Computing (“CISC”), Reduced Instruction Set Computing (“RISC”), or computing via a Very Long Instruction Word (“VLIW”). In at least one embodiment, the processor core(s) may each process a different instruction set, which may include instructions to facilitate emulation of other instruction sets. In at least one embodiment, the processor core(s) may also include other processing devices, such as a digital signal processor (“DSP”).

In at least one embodiment, the processor(s) includes cache memory (“cache”). In at least one embodiment, processor(s) can have a single internal cache or multiple levels of internal cache. In at least one embodiment, cache memory is shared among various components of processor(s). In at least one embodiment, the processor(s) also uses an external cache (e.g., a Level 3 (“L3”) cache or Last Level Cache (“LLC”)) (not shown), which may be shared among processor core(s) using known cache coherency techniques. In at least one embodiment, the register file is additionally included in processor(s) which may include different types of registers for storing different types of data (e.g., integer registers, floating point registers, status registers, and an instruction pointer register). In at least one embodiment, the register file may include general-purpose registers or other registers.

In at least one embodiment, the one or more processor(s) are coupled with one or more interface bus(es) to transmit communication signals such as address, data, or control signals between processor(s) and other components in the processing system. In at least one embodiment interface bus(es) can be a processor bus, such as a version of a Direct Media Interface (“DMI”) bus. In at least one embodiment, the interface bus(es) is not limited to a DMI bus and may include one or more of the Peripheral Component Interconnect buses (e.g., “PCI,” PCI Express (“PCIe”)), memory buses, or other types of interface buses. In at least one embodiment, the processor(s) include an integrated memory controller and a platform controller hub. In at least one embodiment, memory controller facilitates communication between a memory device and other components of the processing system, while a platform controller hub (“PCH”) provides connections to Input/Output (“I/O”) devices via a local I/O bus.

In at least one embodiment, the memory device herein can be a dynamic random access memory (“DRAM”) device, a static random access memory (“SRAM”) device, flash memory device, phase-change memory device, or some other memory device having suitable performance to serve as processor memory. In at least one embodiment, the memory device can operate as system memory for the processing system, to store data and instructions for use when one or more processor(s) executes an application or process. In at least one embodiment, the memory controller also couples with an optional external graphics processor, which may communicate with one or more graphics processor(s) in processor(s) to perform graphics and media operations. In at least one embodiment, a display device can connect to the processor(s). In at least one embodiment the display device can include one or more of an internal display device, as in a mobile electronic device or a laptop device or an external display device attached via a display interface (e.g., DisplayPort, etc.). In at least one embodiment, the display device can include a head mounted display (“HMD”) such as a stereoscopic display device for use in virtual reality (“VR”) applications or augmented reality (“AR”) applications.

In at least one embodiment, a platform controller hub enables peripherals to connect to the memory device and the processor(s) via a high-speed I/O bus. In at least one embodiment, the I/O peripherals include, but are not limited to, an audio controller, a network controller, a firmware interface, a wireless transceiver, touch sensors, a data storage device (e.g., hard disk drive, flash memory, etc.). In at least one embodiment, a data storage device can connect via a storage interface (e.g., SATA) or via a peripheral bus, such as PCI, or PCIe. In at least one embodiment, touch sensors can include touch screen sensors, pressure sensors, or fingerprint sensors. In at least one embodiment, a wireless transceiver can be a Wi-Fi transceiver, a Bluetooth transceiver, or a mobile network transceiver such as a 3G, 4G, or Long Term Evolution (“LTE”) transceiver. In at least one embodiment, firmware interface enables communication with system firmware, and can be, for example, a unified extensible firmware interface (“UEFI”). In at least one embodiment, a network controller can enable a network connection to a wired network. In at least one embodiment, a high-performance network controller couples with interface bus(es). In at least one embodiment, an audio controller is a multi-channel high definition audio controller. In at least one embodiment, the processing system includes an optional legacy I/O controller for coupling legacy (e.g., Personal System 2 (“PS/2”)) devices to processing system. In at least one embodiment, a platform controller hub can also connect to one or more Universal Serial Bus (“USB”) controller(s) connect input devices, such as a keyboard and mouse combinations, a camera, or other USB input devices.

In at least one embodiment, an instance of memory controller and a platform controller hub may be integrated into a discreet external graphics processor, such as external graphics processor. In at least one embodiment, a platform controller hub and/or a memory controller may be external to one or more processor(s). For example, in at least one embodiment, the processing system can include an external memory controller and a platform controller hub, which may be configured as a memory controller hub and a peripheral controller hub within a system chipset that is in communication with processor(s). In at least one embodiment, the system herein is an electronic device that utilizes a processor. In at least one embodiment, the system herein may be, for example and without limitation, a notebook, a tower server, a rack server, a blade server, a laptop, a desktop, a tablet, a mobile device, a phone, an embedded computer, or any other suitable electronic device.

In at least one embodiment, the system herein may include, without limitation, processor communicatively coupled to any suitable number or kind of components, peripherals, modules, or devices. In at least one embodiment, a processor herein is coupled using a bus or interface, such as an I2C bus, a System Management Bus (“SMBus”), a Low Pin Count (“LPC”) bus, a Serial Peripheral Interface (“SPI”), a High Definition Audio (“HDA”) bus, a Serial Advance Technology Attachment (“SATA”) bus, a USB (versions 1, 2, 3), or a Universal Asynchronous Receiver/Transmitter (“UART”) bus. In at least one embodiment, the FIGS. herein illustrate a system which includes interconnected hardware devices or “chips.” In at least one embodiment, the FIGS. herein may illustrate an exemplary SoC. In at least one embodiment, devices illustrated herein may be interconnected with proprietary interconnects, standardized interconnects (e.g., PCIe) or some combination thereof. In at least one embodiment, one or more components of the FIGS. herein are interconnected using CXL interconnects.

In at least one embodiment, the FIGS. herein may include a display, a touch screen, a touch pad, a Near Field Communications unit (“NFC”), a sensor hub, a thermal sensor, an Express Chipset (“EC”), a Trusted Platform Module (“TPM”), BIOS/firmware/flash memory (“BIOS, FW Flash”), a DSP, a Solid State Disk (“SSD”) or Hard Disk Drive (“HDD”), a wireless local area network unit (“WLAN”), a Bluetooth unit, a Wireless Wide Area Network unit (“WWAN”), a Global Positioning System (“GPS”), a camera (“USB 3.0 camera”) such as a USB 3.0 camera, or a Low Power Double Data Rate (“LPDDR”) memory unit (“LPDDR3”) implemented in, for example, LPDDR3 standard. These components may each be implemented in any suitable manner.

In at least one embodiment, other components may be communicatively coupled to the processor herein through components discussed above. In at least one embodiment, an accelerometer, an Ambient Light Sensor (“ALS”), a compass, and a gyroscope may be communicatively coupled to a sensor hub. In at least one embodiment, a thermal sensor, a fan, a keyboard, and a touch pad may be communicatively coupled to an EC. In at least one embodiment, a speakers, a headphones, and a microphone (“mic”) may be communicatively coupled to an audio unit (“audio codec and class d amp”), which may in turn be communicatively coupled to DSP. In at least one embodiment, an audio unit may include, for example and without limitation, an audio coder/decoder (“codec”) and a class D amplifier. In at least one embodiment, a SIM card (“SIM”) may be communicatively coupled to a WWAN unit. In at least one embodiment, components such as WLAN unit and Bluetooth unit, as well as WWAN unit may be implemented in a Next Generation Form Factor (“NGFF”).

In the following description, numerous specific details are set forth to provide a more thorough understanding of at least one embodiment. However, it will be apparent to one skilled in the art that the inventive concepts may be practiced without one or more of these specific details.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system for receive-buffer allocation in a network, comprising:
at least one network interface controller (NIC) to handle receive requests associated with communication for a device, the at least one NIC to provide a fast path and a slow path for the communication, wherein the slow path is to be used based in part on a rule programmed in the at least one NIC, wherein one or more further rules in the at least one NIC is to enable all of an available receive-buffer allocation for a buffer of the system based in part on burst or elephant flow in the communication and is to enable a threshold receive-buffer allocation that is less than the available receive-buffer allocation for the buffer based in part on at least one predetermined condition.

2. The system of claim 1, wherein the at least one predetermined condition is one of: a non-burst or elephant flow in the communication, heuristics associated with a receive packet metadata indicative of a type of packet, a ratio of buffers of a receive queue to a total amount or number of buffers for all the receive queues of the at least one NIC, or statistics associated with packets per second (PPS) or bytes per second (BPS) for the receive queue of the buffer or associated with total values of the PPS and the BPS for the at least one NIC.

3. The system of claim 1, further comprising:
a rules module to provide one or more rules of the slow path, wherein a fairness rule of the one or more rules is to enable different devices in the system to receive respective available receive-buffer allocations for their respective buffers and is to prevent at least one of the different devices from receiving the available receive-buffer allocation at least once during the burst or elephant flow in the communication or in a subsequent communication.

4. The system of claim 3, wherein the fairness rule is enforced in part using a buffer moderator module to perform one or more checks prior to granting access for one or more of the threshold receive-buffer allocation or the available receive-buffer allocation, from a shared page pool, for at least one of the receive requests.

5. The system of claim 4, further comprising one or more of:
a plurality of NetDevs, wherein the available receive-buffer allocation is from the shared page pool of the system, and wherein the plurality of NetDevs share a direct memory access (DMA) device which utilizes the available receive-buffer allocation for the buffer; or
one or more scalable functions (SFs) associated with a physical function (PF) or a Single Root I/O Virtualization (SR-IOV)-enabled device associated with a PF to share and to use the buffer moderator module.

6. The system of claim 1, wherein the available receive-buffer allocation is based in part on a state of an application programming interface (API) of the device.

7. The system of claim 6, wherein when the API is in a busy state, the buffer is to comprise all the available receive-buffer allocation and when the API is not in the busy state, the buffer is to receive the threshold receive-buffer allocation.

8. The system of claim 6, wherein when the API is not in a busy state, the at least one NIC supports reclaiming of part of the available receive-buffer allocation buffer from the buffer to a shared page pool to provide the threshold receive-buffer allocation for the buffer.

9. The system of claim 1, further comprising:
a hardware switch device driver to support and enforce programmed rules associated with communications from one or more devices of the system and to cause the communication to be provided for the slow path; and
a software switch driver to process the communication in the slow path, wherein the device and the one or more devices are virtual machines or containers which are associated with a virtual port and with a representor port of the at least one NIC.

10. One or more circuits to provide at least one network interface controller (NIC) to handle receive requests associated with communication for a device, the at least one NIC to provide a fast path and a slow path for the communication, wherein the slow path is to be used based in part on a rule programmed in the at least one NIC, wherein one or more further rules in the at least one NIC is to enable all of an available receive-buffer allocation for a buffer of the system based in part on burst or elephant flow in the communication and is to enable a threshold receive-buffer allocation that is less than the available receive-buffer allocation for the buffer based in part on at least one predetermined condition.

11. The one or more circuits of claim 10, wherein the at least one predetermined condition is one of: a non-burst or elephant flow in the communication, heuristics associated with a receive packet metadata indicative of a type of packet, a ratio of buffers of a receive queue to a total amount or number of buffers for all the receive queues of the at least one NIC, or statistics associated with packets per second (PPS) or bytes per second (BPS) for the receive queue of the buffer or associated with total values of the PPS and the BPS for the at least one NIC.

12. The one or more circuits of claim 10, further comprising:
a rules module to provide one or more rules for the slow path, wherein a fairness rule of the one or more rules is to enable different devices in the system to receive respective available receive-buffer allocations for their respective buffers and is to prevent the device from receiving the available receive-buffer allocation at least once during the burst or elephant flow in the communication or in a subsequent communication.

13. The one or more circuits of claim 10, further comprising a plurality of NetDevs, wherein the available receive-buffer allocation is from a shared page pool of the system, and wherein the plurality of NetDevs share a direct memory access (DMA) device which utilizes the available receive-buffer allocation for the buffer.

14. The one or more circuits of claim 10, wherein the available receive-buffer allocation is based in part on a state of an application programming interface (API) of the device.

15. The one or more circuits of claim 14, wherein when the API is in a busy state, the buffer is to comprise all the available receive-buffer allocation and when the API is not in the busy state, the buffer is to receive the threshold receive-buffer allocation.

16. The one or more circuits of claim 14, wherein when the API is not in a busy state, the at least one NIC supports reclaiming of part of the available receive-buffer allocation buffer from the buffer to a shared page pool to provide the threshold receive-buffer allocation for the buffer.

17. The one or more circuits of claim 10, further comprising:
a hardware switch device driver to support and enforce programmed rules associated with communications from one or more devices of the system and to cause the communication to be provided for the slow path; and
a software switch driver to process the communication in the slow path, wherein the device and the one or more devices are virtual machines or containers which are associated with a virtual port and with a representor port of the at least one NIC.

18. A method for receive-buffer allocation in a network, comprising:
providing at least one network interface controller (NIC) to handle receive requests associated with communication for a device;
providing a fast path and a slow path for the communication using the at least one NIC;
enabling the slow path to be used for the communication based in part on a rule programmed in the at least one NIC; and
enforcing one or more further rules in the at least one NIC to enable all of an available receive-buffer allocation for a buffer based in part on burst or elephant flow in the communication and to enable a threshold receive-buffer allocation that is less than the available receive-buffer allocation for the buffer based in part on at least one predetermined condition.

19. The method of claim 18, further comprising:
providing a rules module in the slow path for one or more rules;
enabling, using a fairness rule of the one or more rules, different devices to receive respective available receive-buffer allocations for their respective buffers; and
preventing at one of the different devices from receiving the available receive-buffer allocation during the burst or elephant flow in the communication or in a subsequent communication.

20. The method of claim 18, further comprising:
providing a plurality of NetDevs for the at least one NIC;
enabling the available receive-buffer allocation to be provided from a shared page pool; and
enabling the plurality of NetDevs to share a direct memory access (DMA) device which utilizes the available receive-buffer allocation for the buffer.
